(19) United States
(12) Patent Application Publication
(10) Pub. No.: US 2023/0315661 A1
(43) Pub. Date: Oct. 5, 2023

(54) METHODS AND APPARATUS TO CONFIGURE AN INTEGRATED CIRCUIT USING A DIRECT MEMORY ACCESS CONTROLLER

(71) Applicant: Texas Instruments Incorporated, Dallas, TX (US)

(72) Inventor: Michael Zwerg, Dallas, TX (US)

(21) Appl. No.: 18/129,665

(22) Filed: Mar. 31, 2023

Related U.S. Application Data
(60) Provisional application No. 63/326,306, filed on Apr. 1, 2022.

(51) Int. Cl. G06F 13/28; G06F 13/16; G06F 12/02

(52) U.S. Cl. CPC G06F 13/28; G06F 13/1673; G06F 12/0238

(57) ABSTRACT

An example apparatus includes a first memory configured to store a table, and a direct memory access controller coupled to the first memory and including a second memory local to the direct memory access controller, the direct memory access controller configured to read a first set of data from a first location in the table, wherein the first set of data includes an address, write the first set of data from the table to the second memory of the direct memory access controller, read a second set of data from a second location in the table, the second location different than the first location, and write the second set of data to a third location in the first memory, wherein the third location corresponds to the address of the first set of data.

### RELATED APPLICATION

This patent claims the benefit of and priority to U.S. Provisional Patent Application No. 63/326,306, which was filed on Apr. 1, 2022, which is incorporated by reference herein in its entirety.

### TECHNICAL FIELD

This description relates generally to integrated circuitry, and more particularly to methods and apparatus to configure an integrated circuitry using a direct memory access controller.

### BACKGROUND

When an integrated circuit (IC) is powered on, a process is implemented to configure components of the IC. The configurations may be stored in memory and accessed to perform the configuration process. For example, the data stored in the memory is accessed at startup to configure the IC components such as input/outputs (e.g., to configure as an input, output, and/or tristate), analog to digital converters (ADCs), etc. After the components of the IC are configured, the IC can start normal operation.

### SUMMARY

For configuration of an integrated circuit using a direct memory access controller, an example apparatus includes a first memory configured to store a table, and a direct memory access controller coupled to the first memory and including a second memory local to the direct memory access controller, the direct memory access controller configured to read a first set of data from a first location in the table, wherein the first set of data includes an address, write the first set of data from the table to the second memory of the direct memory access controller, read a second set of data from a second location in the table, the second location different than the first location, and write the second set of data to a third location in the first memory, wherein the third location corresponds to the address of the first set of data.

### BRIEF DESCRIPTION OF THE DRAWINGS

FIG. 1 is a block diagram of an integrated circuit described in conjunction with examples disclosed herein.

FIG. 2 is a diagram of direct memory access circuitry of FIG. 1.

FIG. 3 is a diagram illustrating operation of the direct memory access circuitry of FIG. 1 in conjunction with examples disclosed herein.

FIG. 4 is an example state diagram corresponding to operation of the direct memory access circuitry of FIG. 1.

FIG. 5 is a flowchart representative of instructions and/or operations to implement the direct memory access circuitry of FIG. 1.

FIG. 6 is a block diagram of an example processing platform structured to execute the instructions of FIG. 5 to implement the table generation circuitry and/or direct memory access circuitry of FIGS. 1 and/or 2.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

An integrated circuit (IC) (also referred to as a chip or microchip) is a group of circuits on semiconductor material. A system on a chip (SoC), a microcontroller unit (MCU), etc. are types of ICs. In some examples, an IC can include components having configurable options that support applications. For some applications, a fast startup operation and/or startup protocol and configuration of the IC can avoid errors in and/or damage to the IC. For example, to avoid damage to the IC, a circuit breaker application should identify a short circuit as quickly as possible to eliminate overcurrent caused by the short circuit. In some examples, a central processing unit (CPU) on the chip identifies a short circuit using measurements of a voltage and/or current from an ADC. However, the ADC may not be operational until after the ADC is configured. Accordingly, when the IC is first powered up, the short circuit breaker application may not be able to identify a short circuit until the ADC is enabled and configured. In such an example, the faster the ADC of the IC is configured, the faster the circuit breaker application can identify a short and take a mediating action.

Some ICs utilize a CPU to configure components of the IC by storing configuration data into particular locations in memory that the components can read during configuration. However, this may entail the CPU performing several load and store operations to configure the components, which consumes significant time, thereby delaying the time that, for example, the circuit breaker application can identify a short circuit. Additionally, because the example CPU may be busy storing the configuration data, other operations of the CPU may be delayed until the storing operations are complete, which also delays the time that, for example, the circuit breaker application can begin to identify possible short circuits. Delaying identification of a short circuit increases the risk of damage to the system, which the circuit breaker is supposed to protect against.

Additionally, one or more components may need to be re-configured during runtime to accommodate a function. For example, a universal asynchronous receiver-transmitter (UART) may need to be setup for a communication change based on an external pin trigger. The baud rate, the number of bits, and the framing used by the UART may require reconfiguring. During runtime, utilizing the CPU to configure components delays the CPU from performing other tasks, thereby corresponding to a less efficient IC.

Examples disclosed herein configure components of an IC and/or any other circuit using a direct memory access (DMA) controller, which results in a faster and more efficient IC. Examples disclosed herein facilitate a protocol for storing configuration information in memory so that a DMA controller can quickly and efficiently configure components without use of the CPU. Examples disclosed herein extend DMA controller operation to allow for a table mode processing using pairs of data that include a destination address and destination data to transfer configuration data quickly and efficiently in memory. In this manner, the CPU can be freed up to perform other actions rather than accessing and storing configuration data. Additionally, when configuration data is stored according to examples disclosed herein, the DMA controller can configure components faster than a CPU. Thus, in one example, a short circuit breaker application can identify a short circuit from in a shorter time from power up using convention techniques, thereby reducing the likelihood that damage will occur due to a short circuit. Accordingly, examples disclosed herein correspond to faster, more efficient, and safer use of an SoC, IC, MCU, and/or any other circuit.

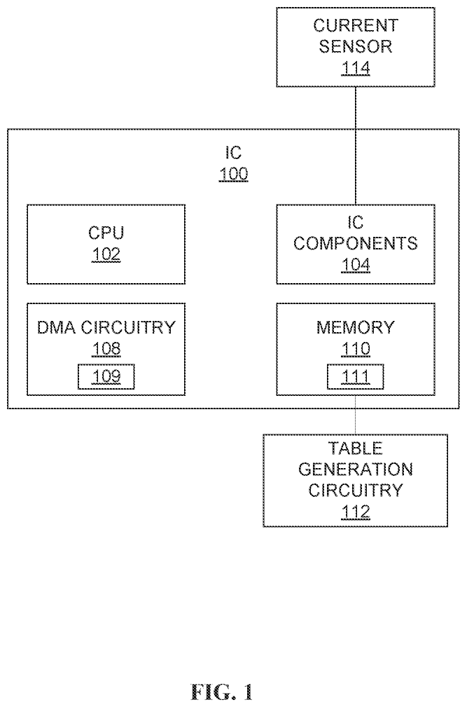

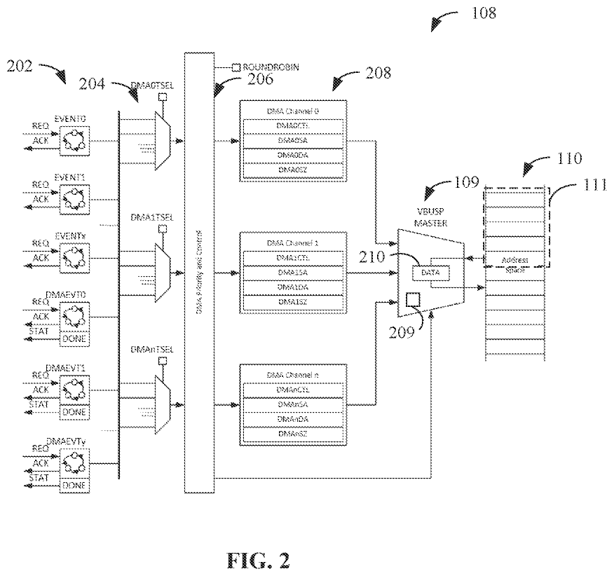

FIG. 1 is a schematic diagram of an example integrated circuit (IC) 100. The IC 100 may be a system-on-a-chip, a microcontroller unit, and/or any other circuitry. The example IC 100 of FIG. 1 includes an example CPU 102, example IC components 104, example DMA circuitry 108, an example DMA primary controller 109, example memory 110, and an example configuration table 111. FIG. 1 further includes an example current sensor 114. In some examples, the IC 100 includes table generation circuitry 112. In some examples, the table generation circuitry 112 is implemented in a separate device from the IC 100 that can access and/or be connected to the memory 110 of the IC 100. The IC 100 of FIG. 2 may be a SoC, a MCU, and/or any other type of IC.

The example CPU 102 of FIG. 1 is a central processor for the IC 100. The CPU 102 includes circuitry to run applications and/or execute instructions of a program. The instructions may include logic, control, arithmetic input/output operation, etc. Conventionally, the CPU 102 would configure the IC components 104 by accessing the configuration information in a first location of the memory 110 and storing the configuration information in the configuration information in the memory 110 or other memory. However, the CPU 102 may utilize several load and store operations to facilitate the configuration of the IC components 104, which may be time consuming and delays the configuration of the IC components 104. Additionally, this operation may prevent the CPU 102 from performing other tasks.

In some examples, the CPU 102 can execute a circuit breaker application to identify a short circuit and open a switch to prevent overcurrent caused by the short circuit from causing damage to the system. For example, the current sensor 114 can sense a current from a power source and provide a measurement of the current to an analog-to-digital converter (ADC) of the IC components 104. The ADC converts the analog current measurement values to digital values that can be processed by the CPU 102 to identify a short circuit. If the CPU 102 determines that the digital current values correspond to a short circuit, the CPU 102 can transmit a signal to open a switch and/or take another suitable measure to prevent the short circuit from causing damage to the system.

The IC components 104 of FIG. 1 are configurable components (e.g., hardware components) implemented on the IC 100. For example, the IC components 104 may include an analog-to-digital converter (ADC), an input/output (IO) (e.g., a general purpose input output (GPIO)), clocks, power components, timers, communication components, etc. To perform the configuration, the IC components 104 may receive instructions that specify configuration details (e.g., parameters, reference values, etc.) or that specify where the configuration details can be accessed. For example, one of the IC components 104 may access data stored in a dedicated memory location (e.g., of the memory 110 and/or another memory) to determine how to configure the pins of the IO (e.g., as an input, an output, or as a tri-state). In some examples, an ADC (e.g., one of the IC components 104) is configured with reference values and other parameters used to convert analog input signals, such as the analog current measurement provided by current sensor 114. In some such examples, the CPU 102 can utilize the digital output from the configured ADC to identify a short circuit at a power supply and control a switch to decouple components from the power supply to prevent overcurrent caused by the short circuit from damaging the system, as further described below.

The DMA circuitry 108 of FIG. 1 performs direct memory access operations. For example, instead of the CPU 102 performing several load and store operations to store data into a location of the memory 110, the DMA circuitry 108 can access and/or store data to/from the memory 110 and/or other memory independently of the CPU 102. This allows the CPU 102 to perform other tasks while the DMA circuitry 108 accesses (e.g., reads and/or writes) data. Conventionally, a DMA controller of the DMA circuitry 108 may be given a source pointer and a destination pointer.

The DMA circuitry 108 of FIG. 1 reads the data from a location corresponding to the source pointer and writes the data into a location corresponding to the destination pointer. The DMA circuitry 108 includes the DMA primary controller 109 to control operation of the DMA circuitry 108. The DMA primary controller 109 configures the IC components 104 in a fast and efficient matter using a table mode. The table mode protocol may include (a) accessing (e.g., reading) a destination address from a first location, (b) accessing corresponding configuration information from a second location immediately preceding the first location, and (c) storing (e.g., writing) the corresponding configuration information to a location corresponding to the destination address, as further described below in conjunction with FIG. 2.

The memory 110 of FIG. 1 stores configuration information corresponding to the IC components 104. In some examples, the memory 110 is non-volatile memory that stores the configuration information so that when the IC 100 is powered up, the DMA circuitry 108 can copy or move the configuration information from an initially stored location (e.g., the configuration table 111) to a destination location (e.g., in the memory 110, a memory local to one of the IC components 104, and/or another memory (e.g., a volatile memory, cache, a buffer, a register, etc.)) that the IC components 104 can access to initialize the configurations. For example, the destination address may be a configuration register that the corresponding IC component has direct access to. In this manner, the IC component can utilize the configuration information in the destination address to define the configuration of the IC component. Initially, the table generation circuitry 112 stores the configuration information in the configuration table implemented in the memory 110 according to a table mode protocol, as further described below. The configuration information may be updated in the memory 110 based on user and/or manufacturer preferences. The configuration table 111 is a predefined portion of the memory 110 that the DMA circuitry 108 can access to autonomously perform a table mode protocol, as further described below.

The table generation circuitry 112 (e.g., also referred to as debug probe circuitry, flash device bootloader circuitry, programmer circuitry, etc.) of FIG. 1 generates the configuration table 111 in the memory 110. For example, the IC 100 may include a dedicated portion of the memory 110 for the configuration table 111. For example, during manufacturing, the table generation circuitry 112 may be implemented in a separate device (e.g., computer, IC, etc.) that accesses the memory 110 to store configuration information related to the IC components 104 in a dedicated portion of the memory 110. In some examples, the table generation circuitry 112 is implemented in the IC 100 to store configuration and/or reconfiguration information in the configuration table 111. In this manner, a user can select and/or adjust the configuration information of the IC components 104 and the table generation circuitry 112 can update the configuration table 111 to reflect the selected and/or adjusted configuration information. Additionally or in the alternative, some or all of the configuration table 111 may located in a read-only portion of memory 110 that is be programmed with configuration information at time of manufacture. After the configuration table 111 is initialized in the dedicated portion of the memory 110, the DMA circuitry 108 can access the configuration table 111 to directly or indirectly configure one or more of the IC components 104.

The configuration information of the IC components 104 are stored in the configuration table 111 of the memory 110 according to a table mode protocol. The table mode protocol corresponds to how to store the configuration information and corresponding destination location information into the configuration table 111 of the memory 110. The structure of the configuration table 111 allows the DMA circuitry 108 to quickly and efficiently move the configuration information from the source location to the destination location without a set of discrete instructions from the CPU 102, and in some examples without any CPU 102 instructions. The table mode protocol may specify storing a destination memory address for corresponding configuration information at a first location and storing the corresponding configuration information at a second subsequent location (e.g., immediately adjacent to) to the first location. For example, the table generation circuitry 112 may store (a) a first entry at a first address within the configuration table (e.g., memory address 0) that specifies a destination memory address that is accessible by an ADC for a set of configuration information for the ADC and (b) a second entry at a second address within the configuration table 111 (e.g., memory address 1) different from (e.g., subsequent) the first memory address that specifies the configuration information for the ADC. In this manner, the DMA circuitry 108 can access the destination memory address from the first location, access the corresponding configuration information from the immediately subsequent second location, and store the corresponding configuration information at the accessed destination memory address.

Using the table mode protocol, the DMA circuitry 108 can copy or move the configuration information to configure the IC components 104 faster than the CPU 102 can move the configuration information. Additionally, utilizing the DMA circuitry 108 allows the CPU 102 to execute other instructions while the DMA circuitry 108 performs the table mode protocol to move the configuration information. The table generation circuitry 112 may be located inside the IC 100 or in another component. For example, the table generation circuitry 112 may store the initial configuration information in the example memory 110 based on the table protocol during manufacture and/or initiation of the IC 100. In some examples, the table generation circuitry 112 may be included in the IC 100 so that a user can adjust the configuration preferences and the table generation circuitry 112 can adjust the configuration data stored in the memory 110 according to the user adjustments.

FIG. 2 is a schematic diagram of the DMA circuitry 108 to access the memory 110 and/or the configuration table 111 of FIG. 1. The example DMA circuitry 108 of FIG. 1 includes the example DMA primary controller 109 of FIG. 1. The example DMA circuitry 108 further includes example interfaces 202, example multiplexers 204, example priority control circuitry 206, example DMA channels 208, example mode control circuitry 209, and example local memory 210 (e.g., a buffer, register, etc.).

In regular mode, the DMA circuitry 108 may obtain requests (e.g., corresponding to events) to read and/or write data from/into the memory 110 via one or more of the interfaces 202. The interfaces 202 responds to a request with an acknowledgement. The requests are provided to the priority control circuitry 206 via the multiplexers 204. The priority control circuitry 206 prioritizes and controls the order in which DMA requests are performed via the DMA channels 208. In some example, each of the DMA channels 208 is assigned a set of requests from a particular IC component 104 selected by the priority control circuitry 206. To perform a DMA operation in a first mode, the DMA request and/or any request parameters are passed to the DMA primary controller 109 via one of the DMA channels 208. The DMA parameters may include DMA information (e.g., number of bits per operation), a source address in memory 110, a destination address to write any read data to, and/or a counter (e.g., corresponding to a number of DMA operations to complete the request). In regular mode, the DMA primary controller 109 stores the obtained destination address from the request in the local memory 210. Additionally, the DMA primary controller 109 reads a set of data from a location in the memory 110 corresponding to the source address (e.g., from the request). Then, the DMA primary controller 109 stores the accessed data in a location corresponding to the destination address. The DMA primary controller 109 decrements the counter when the operation is complete and performs another iteration until the counter reaches zero. To store the accessed data from the source address in a location corresponding to the destination address, the DMA primary controller 109 sets a pointer used for writing data to the location based on the information (e.g., destination address) stored in the local memory 210.

The mode control circuitry 209 of FIG. 2 is included in the DMA primary controller 109 to adjust the operation for the DMA circuitry 108 from the regular mode (e.g., a first mode) to the table mode (e.g., a second mode). The mode control circuitry 209 can initiate the table mode during manufacturing, startup of the IC 100, and/or based on a trigger from the CPU 102 (e.g., after a configuration update). As further described below, during table mode the DMA circuitry 108 can perform operations without obtaining a DMA request with a source address, a destination address, etc. Instead, during table mode, the DMA circuitry 108 accesses data from the configuration table 111 (e.g., the predefined location of the memory 110) and moves configuration data stored in the configuration table 111 to destination addresses that are also stored in the configuration table 111. In an example, the DMA circuitry 108 reads a first set of table data (e.g., destination address(es) accessible by the IC components 104) from the table 111 in the memory 110 and stores the first set of data in the local memory 210. The DMA primary controller 109 may then read a second set of table data (e.g., configuration data for the IC components 104 to write to the destination addresses) from the table 111 in the memory. Then, the DMA primary controller 109 stores the configuration data in a location corresponding to the destination address(es) in local memory 210. In this manner, the DMA primary controller 109 can perform a configuration protocol without obtaining instructions from the CPU 102 that defines source address(es) and/or destination address(es) for the configuration data. Rather, the DMA primary controller 109 can simply access the configuration data and corresponding destination address data from the configuration table 111, as further described below.

In table mode, instead of obtaining a destination address from a component or from the CPU 102, the DMA primary controller 109 can autonomously perform direct memory access operations without obtaining a request from another component or the CPU 102. For example, the DMA primary controller 109 can autonomously access the destination information and configuration information from the configuration table 111 and store the configuration information at the corresponding destination information without obtaining a request. For example, during a startup operation of the IC 100, because the DMA primary controller 109 can start the table protocol at the first entry of the configuration table 111, the DMA primary controller 109 can autonomously move configuration data to configure the IC components 104 during the table mode without waiting for instructions (e.g., corresponding to a source address or a destination address) from the CPU 102. The example DMA primary controller 109 accesses the first set of data from a first location of the configuration table 111 in the memory 110 (e.g., a predefined starting location). As described above, the first set of data corresponds to one or more destination address(es) for configuration information. The DMA primary controller 109 stores the first set of table data (e.g., the destination address(es)) in the local memory 210. The local memory may be a buffer, a cache, one or more registers, one or more latches, etc. The DMA primary controller 109 sets a pointer that points to a location of memory based on the first set of table data (e.g., the destination address). The DMA primary controller 109 accesses a second set of table data from a second location adjacent (e.g., subsequent) to the first location of the configuration table 111 in the memory 110. The second set of table data includes the configuration data to be stored in the destination address (e.g., stored in the local memory and used to set the pointer). After accessing the second set of table data, the DMA primary controller 109 stores the second set of table data at the destination location based on the first set of data stored in the local memory 210 (e.g., using the pointer set to the destination location).

After the first configuration data has been stored at the destination address, the DMA primary controller 109 continues to move additional configuration information to corresponding destination address(es) until the DMA primary controller 109 has processed the entries in the configuration table 111. The configuration information at the destination location(s) is/are used to configure one or more of the IC components 104. In some examples, the configuration table 111 is stored at a predefined location of the memory 110 so that the DMA primary controller 109 can start the table protocol without obtaining the location of the configuration table 111 from another component. In some examples, the starting location of the configuration table 111 is provided to the DMA primary controller 109 from the CPU 102.

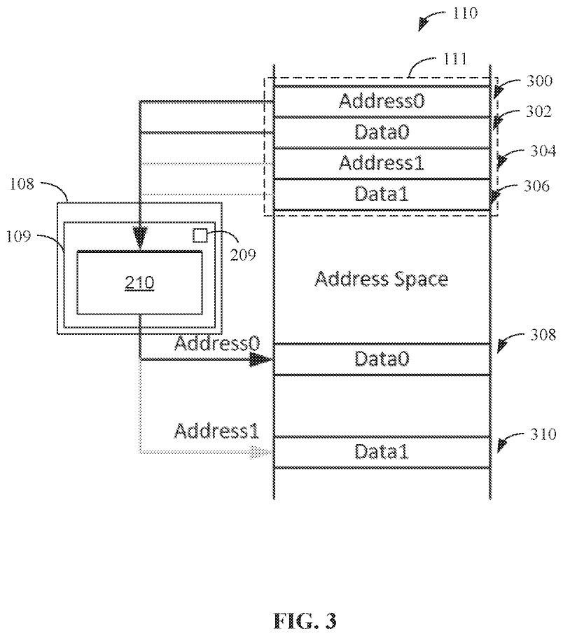

FIG. 3 illustrates an example table mode operation. FIG. 3 includes the example memory 110 of FIG. 1 and the example DMA primary controller 109 of FIG. 2. FIG. 3 further includes memory locations 300, 302, 304, 306, 308, 310. Although the example of FIG. 3 includes six memory locations in the memory 110, the DMA primary controller 109 may perform the table mode operation using any number of locations in any number of memories.

In the example of FIG. 3, the configuration table 111 starts at the first memory location and ends at the fourth memory location 306. As described above, the first location 300 includes a destination address for configuration data stored in a subsequent location (e.g., the second location 302) and the third location 304 includes a destination address for configuration data stored in a subsequent location (e.g., the fourth location 306). For example, the configuration information (e.g., data0) needed to configure an IC component 104 (e.g., an IO of IC 100) is stored in the second memory location 302 and the destination location (e.g., address0) for the IO configuration information is stored in the first memory location 300. In such an example, the configuration information (e.g., data1) needed to configure an ADC is stored in the third memory location 306 and the destination location (e.g., address1) for the ADC configuration information is stored in the third memory location 304.

In this manner, when the DMA primary controller 109 is operating in table mode, the DMA primary controller 109 accesses and/or reads the first set of table data from the first memory location 300 (e.g., address0), stores the first set of table data (e.g., address0) in the local memory 210 of FIG. 2, accesses and/or reads the second set of table data from the second memory address location 302 (e.g., data0), and stores the second set of table data (e.g., data0) to the memory location 308 corresponding to the first set of table data (e.g., address0). After the first configuration data (e.g., data0) is stored at the first memory address (e.g., address0), the DMA primary controller 109 accesses and/or reads a third set of data from the third memory location 304 (e.g., address1), stores the third set of data (e.g., address1) in the local memory 210 of FIG. 2, accesses and/or reads a fourth set of data from the fourth memory address location 306 (e.g., data1), and stores the fourth set of data (e.g., data1) to the memory location 310 corresponding to third set of data (e.g., address1). In such an example, the IO can be configured using the data0 stored in the memory location 308 corresponding to the address0 and the ADC can be configured using the data1 stored in the memory location 310 corresponding to address1. Although the example of FIG. 3 includes DMA to/from the memory 110, the DMA may be from the memory 110 to another memory.

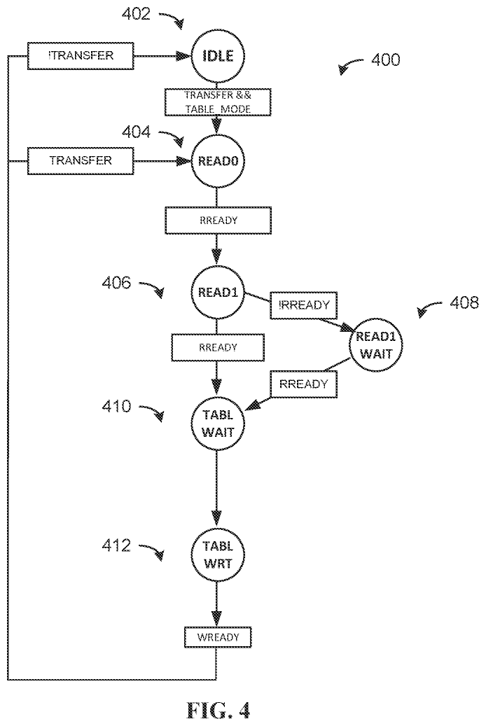

FIG. 4 is an example state diagram 400 corresponding to the table mode operation described in FIG. 3. The state diagram 400 includes example states 402, 404, 406, 410, 412, 412 connected by transition conditions.

The first state 402 is an idle state. If there is a trigger to transfer data and the DMA circuitry 108 is in table mode, the DMA circuitry 108 transitions from the first state 402 to the second state 404. The second state 404 is a first read state (e.g., READ0). As described above, the DMA circuitry 108 reads a first value at a first location of the configuration table 111 in the memory 110. The first location corresponds to a destination address for configuration data stored in a subsequent memory location. As described above, the DMA circuitry 108 stores the first value corresponding to the destination address in the local memory 210 of the DMA primary controller 109. After the DMA circuitry 108 is ready (e.g., the first set of table data is stored in the local memory 210), the DMA circuitry 108 transitions from the second state 404 to the third state 406.

The third state 406 is a second read state (e.g., READ1). As described above, the DMA circuitry 108 reads a second value at a second location subsequent to the first location of the configuration table 111 in the memory 110. The second location corresponds to the configuration information that is to be stored at the destination location represented by the first set of table data stored in the local memory 210 of the DMA primary controller 109. If the DMA circuitry 108 is not ready to complete the read operation, the DMA circuitry 108 may transition from the third state 406 to the fourth state 408. The fourth state 408 is a read1 wait state that waits for the read operation to be complete.

After the DMA circuitry 108 is ready (e.g., the second set of table data has been accessed) and table mode is true, the DMA circuitry 108 transitions from the third state 406 and/or the fourth state 408 to the fifth state 410. The fifth state 410 is a table wait state (e.g., TABL WAIT). The table wait state corresponds to waiting for a threshold amount of time so that the DMA circuitry 108 can control the address pointer to point to the destination address (e.g., based on the first set of table data stored in the local memory 210). In some examples, a clock may track time to determine when the threshold amount of time has occurred to transition into the sixth state 412. After the threshold amount of time has occurred, the fifth state 410 transitions into the sixth state 412. The sixth state 412 is a write state (e.g., TABLWRT). During the sixth state 412, the DMA circuitry 108 writes the accessed data at the third state 406 to the destination address accessed at the second state 404 and stored in the local memory 210. After the write is complete, the DMA circuitry 108 can return to the second state 404 perform another DMA if there are more entries in the configuration table or return back to idle mode (e.g., for another transfer). Alternatively, the DMA circuitry 108 can return to the first state 404 if there are not more entries (e.g., no transfer).

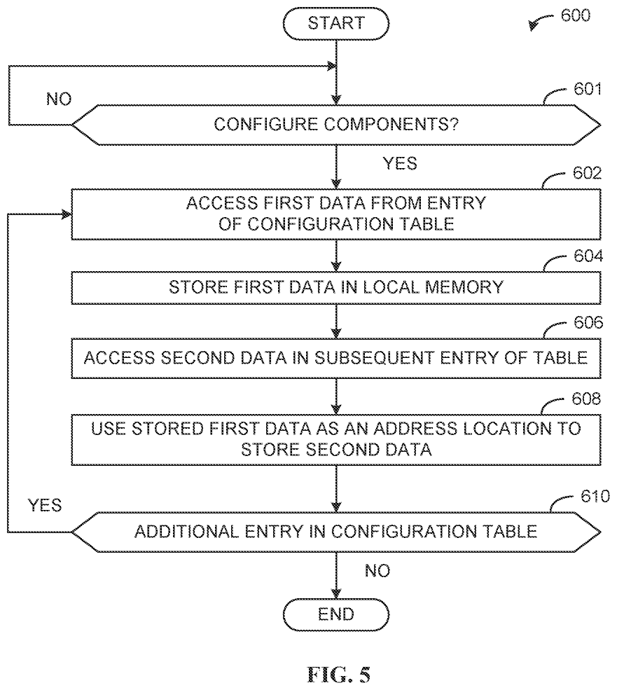

FIG. 5 is an example flowchart 500 representative of instructions and/or functionality of the DMA circuitry 108 of FIGS. 1 and/or 2 and/or a method corresponding to examples disclosed herein. The example flowchart 500 begins at block 501 when the mode control circuitry 209 determines whether to configure or reconfigure one or more of the IC components 104. The mode control circuitry 209 determines that one or more IC components 104 is to be configured at startup (e.g., during a startup protocol) and/or based on a trigger from the CPU 102 (e.g., after a user adjusts the configuration information).

If the mode control circuitry 209 determines that the IC components 104 should not be configured or reconfigured (block 501: NO), control returns to block 501 until one or more of the IC components 104 are to be configured. For example, the mode control circuitry 209 can control the DMA primary controller 109 to operate in regular mode to perform DMA operations based on requests from one or more components of the IC 100. If the mode control circuitry 209 determines that the IC components 104 should be configured or reconfigured (block 501: YES), the mode control circuitry 209 causes the DMA to enter the table mode, thereby causing the example DMA primary controller 109 to access a first set of table data from an entry of the configuration table 111 (block 502). As described above, the configuration table 111 corresponds to a predefined region of the memory 110 and the first set of table data corresponds to a destination address for configuration data stored in a subsequent location.

At block 504, the example DMA primary controller 109 stores the first set of table data (e.g., the destination address of configuration information corresponding to an IC component) in the local memory 210 of FIG. 2. As further described below, the DMA primary controller 109 uses the destination address stored in the local memory 210 to set an address pointer for storing data (e.g., the configuration data) at a particular location that corresponds to the information stored in the local memory 210. At block 506, the DMA primary controller 109 accesses a second set of table data in a subsequent entry of the configuration table 111. For example, if the first set of table data was accessed from a first location corresponding to address 0, the DMA primary controller 109 accesses the second set of table data from the location corresponding to address 1. As described above, the second set of table data is the configuration data that is to be stored at the destination address to configure one or the IC components 104.

At block 508, the example DMA primary controller 109 uses the stored first set of table data as an address location to store the second set of table data. For example, the DMA primary controller 109 may set an address pointer based on the value (e.g., destination address) stored in the local memory 210 and store the second set of table data at the destination location based on the set address pointer. At block 510, the example DMA primary controller 109 determines if there is an additional entry in the configuration table 111 to process. Because the configuration table 111 is a predefined region of the memory 110, the DMA primary controller 109 can start at the first location of the configuration table 111 and continue processing until the last location of the configuration table 111. If the example DMA primary controller 109 determines that there is an additional entry in the configuration table 111 (block 510: YES), control returns to block 502 to process the additional entry. If the example DMA primary controller 109 determines that there is not an additional entry in the configuration table 111 (block 510: NO), control ends.

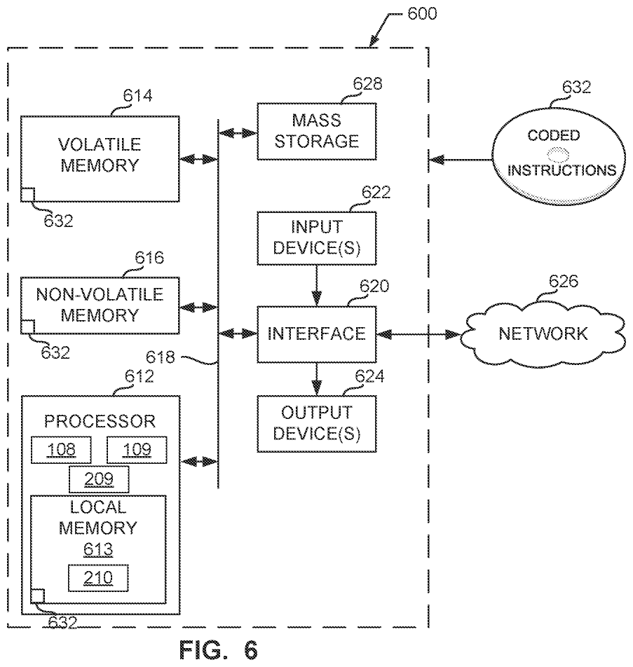

FIG. 6 is a block diagram of an example programmable circuitry platform 600 structured to execute and/or instantiate the example machine-readable instructions and/or the example operations of FIGS. 5 and/or 5 to implement the DMA circuitry 118 and/or the table generation circuitry 112 of FIGS. 1 and/or 2. The programmable circuitry platform 600 can be, for example, a server, a personal computer, a controller, a microcontroller, a workstation, a self-learning machine (e.g., a neural network), or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the DMA circuitry 108, the DMA primary controller 109, and/or the mode control circuitry 209 of FIGS. 1 and/or 2.

The programmable circuitry 612 of the illustrated example includes a local memory 613 (e.g., a cache, registers, etc.). The local memory 613 implements the example local memory 210 of FIG. 2. The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616. One or more of the memories 614, 616 may implement the memory 110 of FIG. 1.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 5 and/or 5, may be stored in the mass storage device 628, in the volatile memory 614, in the non-volatile memory 616, and/or on at least one non-transitory computer readable storage medium such as a CD or DVD which may be removable.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

Numerical identifiers such as “first”, “second”, “third”, etc. are used merely to distinguish between elements of substantially the same type in terms of structure and/or function. These identifiers, as used in the detailed description, do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

Example methods, apparatus, systems, and articles of manufacture to configure an integrated circuitry using a direct memory access controller are disclosed herein. Further examples and combinations thereof include the following: Example 1 includes an apparatus comprising a first memory configured to store a table, and a direct memory access controller coupled to the first memory and including a second memory local to the direct memory access controller, the direct memory access controller configured to read a first set of data from a first location in the table, wherein the first set of data includes an address, write the first set of data from the table to the second memory of the direct memory access controller, read a second set of data from a second location in the table, the second location different than the first location, and write the second set of data to a third location in the first memory, wherein the third location corresponds to the address of the first set of data.

Example 2 includes the apparatus of example 1, wherein the direct memory access controller is to set a pointer to a destination address based on the first set of data in the second memory.

Example 3 includes the apparatus of example 1 further comprising a component coupled to the first memory, wherein the second set of data includes configuration data of the component of an integrated circuit, and the component is configured to perform a configuration process that includes reading the configuration data from the first memory.

Example 4 includes the apparatus of example 1, wherein the first location corresponds to a starting location in the table implemented in the first memory.

Example 5 includes the apparatus of example 1, wherein the direct memory access controller is configured to perform the reading of the first set of data during a startup operation.

Example 6 includes the apparatus of example 1, wherein the direct memory access controller is configured to perform the reading of the first set of data in response to a change in the second set of data.

Example 7 includes the apparatus of example 1, wherein the second location is immediately adjacent to the first location.

Example 8 includes a non-transitory computer readable storage medium comprising instructions which, when executed, cause processor circuitry to at least access a first set of data from a first location in a configuration table in memory, store the first set of data from the configuration table in a buffer, access a second set of data from a second location in the configuration table, the second location immediately adjacent to the first location, and store the second set of data at a third location in the memory, the third location corresponding to the first set of data.

Example 9 includes the non-transitory computer readable storage medium of example 8, wherein the first set of data identifies the third location in the memory.

Example 10 includes the non-transitory computer readable storage medium of example 8, wherein the second set of data corresponds to configuration information.

Example 11 includes the non-transitory computer readable storage medium of example 8, wherein the instructions cause the processor circuitry to set a pointer to a destination address based on the first set of data in the buffer.

Example 12 includes the non-transitory computer readable storage medium of example 8, wherein the second set of data is used to configure a component of an integrated circuit.

Example 13 includes the non-transitory computer readable storage medium of example 8, wherein the first location corresponds to a starting location in the configuration table implemented in the memory.

Example 14 includes the non-transitory computer readable storage medium of example 8, wherein the instructions cause the processor circuitry to read the first set of data from the first location during a startup protocol.

Example 15 includes a method comprising reading, using a direct memory access controller, a first set of data from a first location in a configuration table stored in a first memory, storing, using the direct memory access controller, the first set of data in a second memory, the second memory included in the direct memory access controller, reading, using the direct memory access controller, a second set of data from a second location in the configuration table different than the first location, and writing, using the direct memory access controller, the second set of data at a third location in the first memory based on the first set of data.

Example 16 includes the method of example 15, wherein the first set of data identifies the third location in the first memory.

Example 17 includes the method of example 15, wherein the second set of data corresponds to configuration information.

Example 18 includes the method of example 15, further including setting an address pointer to a destination address based on the first set of data in the second memory.

Example 19 includes the method of example 15, wherein the second set of data is used to configure a component of a system on chip.

Example 20 includes the method of example 15, wherein the first location corresponds to a starting location in the configuration table implemented in the first memory.

What is claimed is:

1. An apparatus comprising:
a first memory configured to store a table; and
a direct memory access controller coupled to the first memory and including a second memory local to the direct memory access controller, the direct memory access controller configured to:
read a first set of data from a first location in the table, wherein the first set of data includes an address;
write the first set of data from the table to the second memory of the direct memory access controller;
read a second set of data from a second location in the table, the second location different than the first location; and
write the second set of data to a third location in the first memory, wherein the third location corresponds to the address of the first set of data.

2. The apparatus of claim 1, wherein the direct memory access controller is to set a pointer to a destination address based on the first set of data in the second memory.

3. The apparatus of claim 1 further comprising a component coupled to the first memory, wherein:
the second set of data includes configuration data of the component of an integrated circuit; and
the component is configured to perform a configuration process that includes reading the configuration data from the first memory.

4. The apparatus of claim 1, wherein the first location corresponds to a starting location in the table implemented in the first memory.

5. The apparatus of claim 1, wherein the direct memory access controller is configured to perform the reading of the first set of data during a startup operation.

6. The apparatus of claim 1, wherein the direct memory access controller is configured to perform the reading of the first set of data in response to a change in the second set of data.

7. The apparatus of claim 1, wherein the second location is immediately adjacent to the first location.

8. A non-transitory computer readable storage medium comprising instructions which, when executed, cause processor circuitry to at least:
access a first set of data from a first location in a configuration table in memory;
store the first set of data from the configuration table in a buffer;
access a second set of data from a second location in the configuration table, the second location immediately adjacent to the first location; and
store the second set of data at a third location in the memory, the third location corresponding to the first set of data.

9. The non-transitory computer readable storage medium of claim 8, wherein the first set of data identifies the third location in the memory.

10. The non-transitory computer readable storage medium of claim 8, wherein the second set of data corresponds to configuration information.

11. The non-transitory computer readable storage medium of claim 8, wherein the instructions cause the processor circuitry to set a pointer to a destination address based on the first set of data in the buffer.

12. The non-transitory computer readable storage medium of claim 8, wherein the second set of data is used to configure a component of an integrated circuit.

13. The non-transitory computer readable storage medium of claim 8, wherein the first location corresponds to a starting location in the configuration table implemented in the memory.

14. The non-transitory computer readable storage medium of claim 8, wherein the instructions cause the processor circuitry to read the first set of data from the first location during a startup protocol.

15. A method comprising:
reading, using a direct memory access controller, a first set of data from a first location in a configuration table stored in a first memory;
storing, using the direct memory access controller, the first set of data in a second memory, the second memory included in the direct memory access controller;
reading, using the direct memory access controller, a second set of data from a second location in the configuration table different than the first location; and
writing, using the direct memory access controller, the second set of data at a third location in the first memory based on the first set of data.

16. The method of claim 15, wherein the first set of data identifies the third location in the first memory.

17. The method of claim 15, wherein the second set of data corresponds to configuration information.

18. The method of claim 15, further including setting an address pointer to a destination address based on the first set of data in the second memory.

19. The method of claim 15, wherein the second set of data is used to configure a component of a system on chip.

20. The method of claim 15, wherein the first location corresponds to a starting location in the configuration table implemented in the first memory.
